(19) United States
(12) Patent Application Publication
(10) Pub. No.: US 2024/0109538 A1
(43) Pub. Date: Apr. 4, 2024

(54) VEHICLE HAVING SLOPE DRIVING ASSIST FUNCTION AND METHOD OF CONTROLLING THE SAME

(71) Applicants: Hyundai Motor Company, Seoul (KR); Kia Corporation, Seoul (KR)

(72) Inventors: Sun Young PARK, Ansan-Si (KR); Hui Un Son, Suwon-Si (KR)

(73) Assignees: Hyundai Motor Company, Seoul (KR); Kia Corporation, Seoul (KR)

(21) Appl. No.: 18/117,928

(22) Filed: Mar. 6, 2023

(30) Foreign Application Priority Data
Sep. 28, 2022 (KR) 10-2022-0123509

(51) Int. Cl. B60W 30/18; B60W 10/08; B60W 20/15

(52) U.S. Cl. CPC B60W 30/18009; B60W 10/08; B60W 20/15; B60W 10/06; B60W 2510/244; B60W 2552/15

(57) ABSTRACT

A vehicle and a method of controlling the vehicle including a slope driving assist function includes a first motor, a second motor, and a control unit configured to determine a compensation torque based on a gradient resistance according to the gradient of a driving road on which the vehicle is driving and allocate a total required torque including the compensation torque and driver's required torque to at least one of the first motor and the second motor based on whether the total required torque may be outputted from the second motor.

### CROSS REFERENCE TO RELATED APPLICATION

The present application claims priority to Korean Patent Application No. 10-2022-0123509, filed Sep. 28, 2022, the entire contents of which is incorporated herein for all purposes by this reference.

### BACKGROUND OF THE PRESENT DISCLOSURE

### Field of the Present Disclosure

The present disclosure relates to a vehicle including a slope driving assist function that allows control of the torque output of a motor mounted in the vehicle so that the vehicle may drive on a slope in the same manner as on an even road and a method of controlling the vehicle.

### Description of Related Art

Vehicles are provided with a drive source such as an engine and a motor, and the drive source provides the driving force required for driving by outputting the required torque according to a driver's manipulation of an accelerator pedal. Furthermore, various resistances such as rolling resistance, air resistance, and acceleration resistance (or inertia resistance) as well as the driving force by the drive source act on the vehicle in motion. These resistances act in a direction opposite to the driving force and thus impede the movement of the vehicle, and the driver manipulates the accelerator pedal in consideration of these resistances.

On the other hand, when the vehicle is positioned on a slope, gradient resistance (or slope resistance) is additionally generated according to the gradient of the slope, and the gradient resistance acts on the vehicle along the slope surface downward. As a result, a push phenomenon in which the vehicle is pushed down the slope occurs or an additional resistance acts so that the manipulative sense of the accelerator pedal during the slope driving may feel different from even road driving, increasing the driving difficulty. The risk of accidents also increases.

Techniques for preventing the push phenomenon of the vehicle through a torque control that increases the creep torque when the driver takes his or her foot off the accelerator pedal on a slope have been provided to overcome the present problem. However, the torque control described above is not executed while the driver steps on the accelerator pedal, so adjustment of the driving difficulty is limited during slope driving.

Accordingly, there is a need to propose a method that allows the same manipulation of the accelerator pedal on a slope as on an even road, reducing the driving difficulty and reducing the risk of accidents.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle including a slope driving assist function that allows control of the torque output of motors mounted in the vehicle so that the vehicle may drive on a slope in the same manner as on an even road and a method of controlling the vehicle.

Technical objects to be achieved by the present disclosure are not limited to the technical objects described above, and other technical objects not described will be clearly understood by those skilled in the art to which the present disclosure pertains.

According to an exemplary embodiment of the present disclosure, the vehicle including the slope driving assist function includes a first motor, a second motor, and a control unit configured to determine a compensation torque based on a gradient resistance according to a gradient of a driving road on which the vehicle is driving and allocate a total required torque including the compensation torque and driver's required torque to at least one of the first motor and the second motor based on whether the total required torque may be outputted from the second motor.

For example, the control unit may determine the compensation torque in further consideration of a compensation coefficient preset to correspond to the driving behavior of the vehicle on a road with a specific gradient.

For example, the control unit may determine the compensation torque in further consideration of the weight condition of the vehicle, and the weight condition may be determined based on the driving behavior of the vehicle related to a preset value or an output torque for each vehicle.

For example, the control unit may determine the compensation torque in further consideration of the road surface condition of the driving road, and the road surface condition may be determined based on a preset value or a road type.

For example, an audio/video/navigation/telematics (AVNT) terminal for identifying the current location of the vehicle may be further included, and the road type may be determined based on the current location of the vehicle identified through the AVNT terminal.

For example, the control unit may check the driving behavior of the vehicle according to outputting of the total required torque by at least one of the first motor and the second motor, determine the degree of matching between the driving behavior and a preset target behavior, and adjust the compensation torque so that the degree of matching is equal to or greater than the preset value when the degree of matching is less than the preset value.

For example, the target behavior may be determined based on the driving behavior of the vehicle at a predetermined gradient.

For example, the control unit may reserve at least a portion of an available torque of a motor among the first motor and the second motor, which is to output the compensation torque according to the allocation described above until the compensation torque is outputted through at least one of the first motor and the second motor.

For example, when the total required torque may be outputted from the second motor, the control unit may allocate the total required torque so that the total required torque is outputted through the second motor.

For example, if the first motor may generate power when the total required torque may be outputted from the second motor, the control unit may control so that the first motor charges a battery according to the state of charge (SOC) value of the battery.

For example, when the total required torque may not be outputted from the second motor, the control unit may allocate the total required torque so that the output of the total required torque is split between the first motor and the second motor.

For example, if the torque output of the first motor or the second motor is limited when all the total required torque may not be outputted from the second motor, the control unit may allocate the compensation torque to a motor among the first and second motors with limited torque output and the driver's required torque to another motor among the first and second motors.

For example, the case in which the torque output of the first motor or the second motor is limited includes failure of the first motor or the second motor and overheating of the first motor or the second motor.

For example, when a request for activation of the slope driving assist function is inputted, the control unit may control so that the compensation torque is outputted through at least one of the first motor and the second motor.

According to an exemplary embodiment of the present disclosure, a method of controlling the vehicle including a slope driving assist function includes determining compensation torque based on the gradient resistance according to the gradient of a driving road on which the vehicle is driving and allocating the total required torque including the compensation torque and driver's required torque to at least one of the first motor and the second motor based on whether the total required torque may be outputted from the second motor.

The object of the present disclosure is not limited to the objects described above, and other objects not described may be clearly understood by those skilled in the art from the following description.

According to various embodiments of the present disclosure described above, slope driving assist allows slope driving to be similar to even road driving, reducing the driving difficulty on the slope. The reduced driving difficulty on the slope allows the driver to readily secure the driving feel that the driver desires, improving driving convenience and reducing the risk of accidents.

The effects which may be obtained from the present disclosure are not limited to the effects described above, and other effects that are not mentioned will be clearly understood by those skilled in the art to which the present disclosure pertains from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1A and FIG. 1B are views exemplarily illustrating an example of a powertrain apparatus configuration of a vehicle including a slope driving assist function applicable to various exemplary embodiments of the present disclosure.

FIG. 2 is a block diagram illustrating an example of a control system configuration of a vehicle including a slope driving assist function according to an exemplary embodiment of the present disclosure.

FIG. 3 is a view exemplarily illustrating a configuration of a vehicle including a slope driving assist function according to an exemplary embodiment of the present disclosure.

FIG. 4 is a view for describing the determination of compensation torque for slope driving assist according to an exemplary embodiment of the present disclosure.

FIG. 5 is a flowchart illustrating a control process of a vehicle including a slope driving assist function according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The exemplary embodiment included in the present specification will be described in detail with reference to the accompanying drawings. However, the same or similar components will be provided the same reference numerals irrespective of the drawing numbers, and the repetitive descriptions will be omitted. The suffixes “module” and “unit” for the components used in the following description are provided or interchangeably used only in consideration of the ease of writing the specification and do not have meanings or roles distinct from each other by themselves. When it is determined that the specific description of the related and already known technology may obscure the gist of the exemplary embodiments included in the specification, the specific description will be omitted. Furthermore, it is to be understood that the accompanying drawings are for a better understanding of the exemplary embodiment included in the present specification and that the technical ideas included in the present specification are not limited by the accompanying drawings and include all the modifications, equivalents, or substitutes included in the spirit and technical scope of the present disclosure.

The terms including ordinal numbers such as first, second, and the like may be used to describe various components, but the components are not to be limited by the terms. The terms may only be used for distinguishing one component from the other.

It is to be understood that when a component is referred to as being “connected” or “coupled” to another component, the component may be directly connected or coupled to the another component, but other components may be interposed therebetween. In contrast, when a component is referred to as being “directly connected” or “directly coupled” to another component, it is to be understood that no other component is interposed therebetween.

Singular expressions include plural expressions unless the context explicitly indicates otherwise.

In the present specification, terms such as “comprise” or “have” are intended to indicate the presence of implemented features, numbers, steps, manipulations, components, parts, or combinations thereof described in the specification and are not to be understood to preclude the presence or additional possibilities of one or more of other features, numbers, steps, manipulations, components, parts or combinations thereof.

Furthermore, a unit or control unit included in the names such as a motor unit MCU, a hybrid control unit HCU, and the like is a term only used in the naming of a controller that controls a specific function of a vehicle only and does not mean a generic function unit. For example, each control unit may include a communication device configured to communicate with other control units or sensors to control the functions it is responsible for, a memory configured to store an operating system, logic commands, and input/output information, and one or more processors configured to execute determination, calculation, and decision, and the like required for controlling the functions it is responsible for.

A structure and a control system of a vehicle including a slope driving assist function applicable to various exemplary embodiments of the present disclosure will be described before a method of controlling the vehicle including the slope driving assist function according to the embodiments.

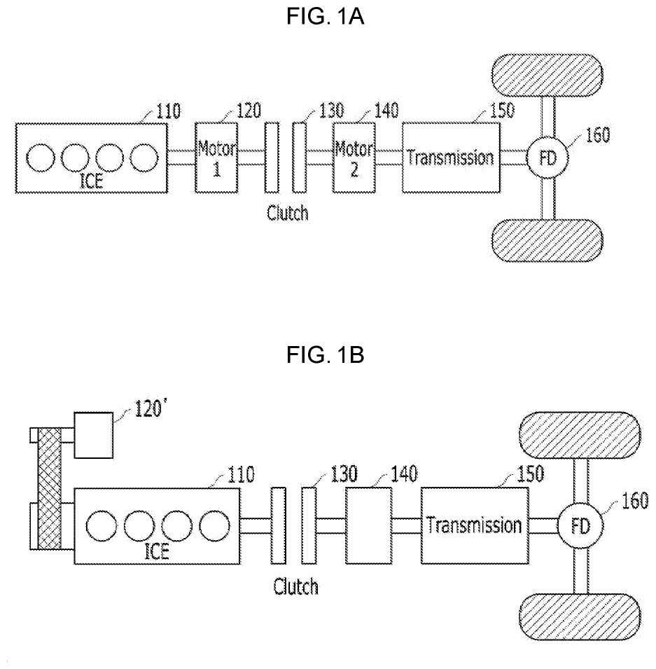

FIG. 1A and FIG. 1B are views exemplarily illustrating a powertrain apparatus configuration of a vehicle including a slope driving assist function applicable to various exemplary embodiments of the present disclosure.

FIG. 1A illustrates a powertrain apparatus of a hybrid vehicle employing a parallel-type hybrid system provided with two motors 120, 140 and an engine clutch 130 between an internal combustion engine (ICE) 110 and a transmission 150. Because the motor 140 is always connected to the input terminal of the transmission 150, the parallel-type hybrid system is also referred to as a transmission mounted electric drive (TMED) hybrid system.

Here, the first motor 120 of the two motors 120, 140 may be disposed between the engine 110 and one end portion of the engine clutch 130, and the engine shaft of the engine 110 and the first motor shaft of the first motor 120 may be connected to each other to rotate together all the time.

One end portion of the second motor shaft of a second motor 140 may be connected to the other end portion of the engine clutch 130 and the other end portion of the second motor shaft may be connected to the input terminal of the transmission 150.

The second motor 140 may have a greater output than the first motor 120, and the second motor 140 is configured as a driving motor. Furthermore, the first motor 120 is configured as a starting motor that cranks the engine 110 when the engine 110 is started, recover rotational energy of the engine 110 through power generation when the engine is turned off, and generate powerusing the power of the engine 110 while the engine 110 is running.

When the driver steps on the accelerator pedal after starting (for example, HEV ready) in a vehicle including a slope driving assist function with the powertrain apparatus illustrated in FIG. 1A and FIG. 1B, the second motor 140 is driven using a battery first while the engine clutch 130 is open. Accordingly, the power of the second motor 140 passes through the transmission 150 and a final drive (FD) 160 and moves the wheels (that is, EV mode). When a greater driving force is required as the vehicle gradually accelerates, the first motor 120, 120′ may operate to crack the engine 110.

When the rotational speed difference between the engine 110 and the second motor 140 falls within a certain range after the engine 110 is started, the engine clutch 130 engages and the engine 110 and the second motor 140 rotate together (that is, a transition from EV mode to HEV mode). Accordingly, while the vehicle undergoes a torque blending process, the output of the second motor 140 may decrease and the output of the engine 110 may increase to satisfy the driver's required torque. The engine 110 may satisfy most of the required torque, and the difference between the engine torque and the required torque may be compensated through at least one of the first motor 120 and the second motor 140. For example, when the engine 110 outputs torque higher than the required torque in consideration of the efficiency of the motor 110, the first motor 120 or the second motor 140 generates as much as the engine torque surplus. When the engine torque falls short of the required torque, at least one of the first motor 120 and the second motor 140 may output torque to fill the shortage.

When a preset engine-off condition is satisfied, like when the vehicle decelerates, the engine clutch 130 is opened and the engine 110 stops (that is, a transition from HEV mode to EV mode). The battery is charged through the second motor using the driving force of the wheels during deceleration, which is referred to as braking energy regeneration or regenerative braking.

In general, a stepped transmission or a multi-plate clutch transmission such as a dual-clutch transmission (DCT) may be employed as the transmission 150.

On the other hand, a vehicle including the slope driving assist function according to an exemplary embodiment of the present disclosure may be applied when a plurality of motors are provided regardless of whether the engine 110 is provided, like when the first motor 120′ is connected to the engine 110 by a pulley and a belt as illustrated in FIG. 1B unlike the illustration in FIG. 1A rather than being disposed between the engine 110 and one end portion of the engine clutch 130, when the first motor is configured as an auxiliary driving motor connected to auxiliary drive wheels while the second motor is configured as the main driving motor connected to main drive wheels, etc.

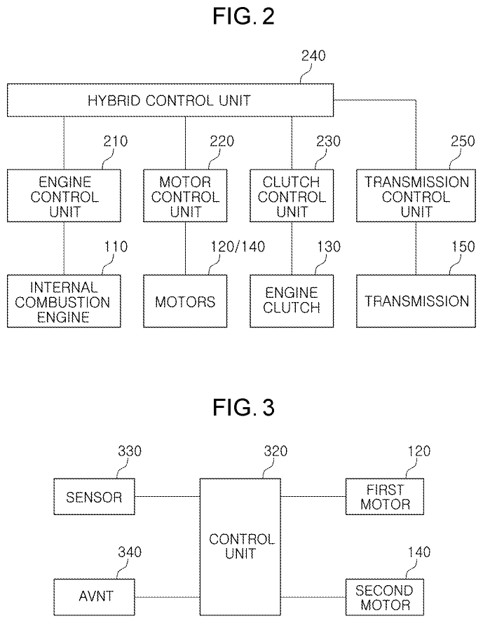

FIG. 2 is a block diagram illustrating an example of a control system configuration of a vehicle including a slope driving assist function according to an exemplary embodiment of the present disclosure.

FIG. 2 shows that a vehicle including the slope driving assist function to which embodiments of the present disclosure are applicable includes the engine 110 which may be controlled by an engine control unit 210, torque of the first motor 120 and the second motor 140 which may be controlled by the motor control unit (MCU) 220, and the engine clutch 130 which may be controlled by a clutch control unit 230 respectively. Here, the engine control unit 210 is also referred to as an engine management system (EMS). Furthermore, the transmission 150 is controlled by a transmission control unit 250.

The motor control unit 220 may control a gate drive unit with a control signal in a form of pulse width modulation (PWM) based on the motor angle, phase voltage, phase current, required torque, and the like of each motor 120, 140, and the gate drive unit may control an inverter that drives each of the motors 120, 140 accordingly.

Each control unit may be connected to a hybrid control unit (HCU) 240 configured to control the overall powertrain apparatus including the mode transition process as an upper control unit and provide the hybrid control unit 240 with the information required for engine clutch control when drive modes are transitioned or gears are shifted and/or the information required for engine stop control as per control of the hybrid control unit 240 or execute operations according to the control signals.

For example, the hybrid control unit 240 decides whether or not to execute transitions between EV-HEV modes or Charging-Depleting (CD)-Charging-Sustaining (CS) modes (in case of Plug-in Hybrid Vehicle (PHEV)) according to the driving condition of the vehicle. To the present end, the hybrid control unit is configured to determine when to open the engine clutch 130 and executes a hydraulic control at the time of opening. Furthermore, the hybrid control unit 240 may determine the states (lock-up, slip, open, and the like) of the engine clutch 130 and control the time to stop the fuel injection of the engine 110. Furthermore, the hybrid control unit may transmit a torque command for controlling the torque of the first motor 120 to the motor control unit 220 and recover the rotational energy of the engine to stop the engine. Furthermore, the hybrid control unit 240 may determine the state of each drive source 110, 120, 140, decides the required driving force to be allocated to each drive source 110, 120, 140 accordingly, and transmit the torque command to the control units 210, 220 configured to control each drive source to satisfy the required torque.

Of course, it is apparent to those skilled in the art that the connection relationship between the control units and the function/classification of each control unit described above are illustrative and are not limited by their names. For example, the control unit 240 may be implemented in a way that a function is provided away to one of other control units, or that a function is provided away to two or more of other control units.

It is to be apparent to those skilled in the art that the configurations in FIG. 1A and FIG. 1B described above assume that the vehicle including the slope driving assist function is a hybrid electric vehicle and that a vehicle including the slope driving assist function which the exemplary embodiments are applicable is not limited to the present structure.

An exemplary embodiment of the present disclosure suggests that the compensation torque to be outputted in addition to the driver's required torque be determined to counter the gradient resistance during slope driving and the total required torque to each motor be allocated based on whether the total required torque including the compensation torque and the driver's required torque may be outputted from a specific motor so that the driver may have the same driving feel during slope driving as during even road driving.

Here, the slope driving may include a case in which a vehicle stopped on a slope starts to drive and a case in which a vehicle driving on an even road enters a slope without stopping at the time of entry. Also, in the instant case, the gradient of the slope may be understood as the angle between the inclined surface of the slope and the horizontal ground as well as the ratio of the vertical distance to the horizontal distance.

FIG. 3 is a view exemplarily illustrating a configuration of a vehicle including a slope driving assist function according to an exemplary embodiment of the present disclosure.

FIG. 3 shows that the vehicle including a slope driving assist function may include the first motor 120, the second motor 140, a control unit 320, a sensor 330, and audio/video/navigation/telematics (AVNT) terminal 340 (hereinafter referred to as “AVNT” for convenience). FIG. 3 mainly illustrates a configuration related to the exemplary embodiment of the present disclosure, and it is apparent to those skilled in the art that a vehicle including a slope driving assist function according to an exemplary embodiment of the present disclosure may include more or fewer configurations.

First, the first motor 120 and the second motor 140 output torque according to the driver's accelerator pedal manipulation so that the driving force is transmitted to the wheels of the vehicle. The vehicle including the slope driving assist function according to various exemplary embodiments of the present disclosure may further include the engine 110 as a drive source in addition to the first motor 120 and the second motor 140, and the types of vehicles may be classified according to the drive source. For example, vehicles may be classified into an HEV when the engine 110 and the motors 120, 140 are included together and into an EV when the engine 110 is not provided and the motors 120, 140 serve as a drive source.

On the other hand, the wheel-based driving force (hereinafter referred to as “driving force” for convenience) required for the driving of the vehicle is subject to the influence of torque outputted from a drive source such as the first motor 120, the second motor 140, and the like, the gear ratio of the transmission 150, the final reduction gear ratio, the transmission efficiency, and [symbol] effective radius of the drive wheel. In the instant case, the driving force is proportional to the torque outputted from the drive source so that the driving force increases as the output torque of the drive source increases, and the total driving force acting on the vehicle is the sum of driving forces by respective drive sources. Accordingly, when an additional driving force is generated to counter the gradient resistance additionally acting on the vehicle during slope driving compared to even road driving, the driver is allowed driving feel similar to the feel of even road driving during slope driving without manipulating the accelerator pedal differently compared to even road driving. The drive source outputs extra torque in addition to the driver's required torque according to the accelerator pedal manipulation to generate the additional driving force.

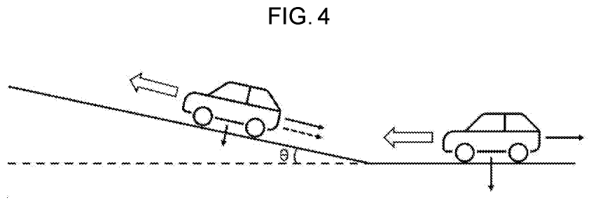

On the other hand, the control unit 320 determines the compensation torque based on the gradient resistance according to the gradient of the driving road and allocates the total required torque to at least one of the first motor 120 and the second motor 140 based on whether the total required torque including the determined compensation torque and the driver's required torque may be outputted from the second motor 140. The determination of the compensation torque will be described in detail below with reference to FIG. 4. The allocation of the total required torque by the control unit 320 will be first described with reference to FIG. 3 in the following.

First, the control unit 320 allocates the total required torque to at least one of the first motor and the second motor based on whether the total required torque including the compensation torque and the driver's required torque may be generated from the second motor 140. Whether the second motor 140 may output the total required torque may be determined in consideration of the torque output specification of the second motor 140.

For example, when the second motor may sufficiently output the total required torque according to the torque output specification, the control unit 320 may allocate the total required torque to the second motor 140 so that the total required torque may be outputted through the second motor 140. Furthermore, when the first motor 120 and the second motor 140 may respectively output the total required torque, the motor including a higher torque output specification among the motors configured for outputting the total required torque may implement the second motor 140 configured to output the total required torque.

Furthermore, when the second motor 140 outputs the total required torque, the control unit 320 may control the first motor 120 to charge the battery according to the state of charge (SOC) value of the battery when the first motor 120 may generate power. This allows control of the first motor 120 to reflect the demand for battery charging. For example, when the second motor 140 alone outputs the total required torque, the battery may be charged through the first motor 120 which is not utilized in outputting torque when the battery SOC is less than a preset value, allowing efficient utilization of a plurality of drive sources provided in the vehicle. On the other hand, when the battery SOC is equal to or greater than a preset value, the first motor 120 is not allowed to charge the battery so that the first motor 120 does not operate unnecessarily when charging is not required.

On the other hand, when all the total required torque may not be outputted from the second motor 140, the control unit 320 may allocate the total required torque so that the output of the total required torque is split between the first motor and the second motor. In the instant case, the total required torque may be allocated at a specific ratio according to the torque output specification of each motor 120, 140 and the like, and the driver's required torque and the compensation torque may be outputted through different motors according to the allocation. For example, any motor among a plurality of motors 120, 140 or a motor provided as the main motor may output the driver's required torque during normal driving, and when output of the compensation torque is required, the remaining motor may output the compensation torque so that the total required torque may be reached rapidly. If the torque output of the first motor 120 or the second motor 140 is limited when all the total required torque may not be outputted from the second motor 140, the compensation torque may be allocated to the motor with the limited torque output and the driver's required torque may be allocated to the remaining motor. The case in which the torque output of the first motor 120 or the second motor 140 is limited includes failure of the first motor 120 or the second motor 140 and overheating of the first motor 120 or the second motor 140. Thus, the actual available torque of each motor 120, 140 may be reflected in the allocation of the total required torque. On the other hand, the control unit 320 may reserve at least a portion of an available torque of a motor among the first motor and the second motor, which is to output the compensation torque according to the allocation until the compensation torque is outputted so that the output of the compensation torque may be secured when a slope is entered. That is, as much as the compensation torque out of the total available torque is secured as reserve torque such as not to be outputted when the driver manipulates the accelerator pedal, and the reserved torque is outputted when the compensation torque is required as the slope is entered. For example, assuming that the total available torque of the second motor 140 is 100 when the compensation torque is outputted through the second motor 140, up to 90 may be used to meet the driver's required torque and 10 may be reserved regardless of the driver's required torque and be used when the compensation torque is required. The reservation of the available torque allows quick reach to the total required torque when a slope is entered and alleviation of an unusual feel in driving likely to be caused by the gradient resistance when an even road changes into a slope.

The control unit 320 may provide a control strategy that allows the proper operation of each of the motors 120, 140 mounted in the vehicle by executing the slope driving assist control in the present way. The powertrain apparatus configuration illustrated in FIG. 1 offers an example. When the second motor 140 configured to serve as the driving motor with greater output than the first motor 120 can amply output the total required torque during EV driving, the second motor 140 may output the total required torque.

In the instant case, the vehicle is driven with the engine clutch 130 decoupled and the first motor 120 configured to execute power generation using the power of the engine 110 may charge the battery when charging is required according to the battery SCO. On the other hand, when charging is not required according to the battery SCO, the engine 110 and the first motor 120 may not be started.

Furthermore, the control unit 320 may allocate the total required torque to the engine 110, the first motor 120, and the second motor 140 according to the driving source configuration, the total required torque, the driving mode, or the like so that the output of the total required torque may be split according to the allocation result.

When the available torque of the second motor 140 is less than the total required torque while a hybrid vehicle is driven in the EV mode, transition into the HEV mode may allow the engine 110 to satisfy the total required torque. When the total required torque is greater than the available torque of the engine 110, at least one of the first motor 120 and the second motor 140 may be additionally used to meet the total required torque. Furthermore, in the case of fuel shortage or engine system failure, the total required torque may be met with the combined torque of the first motor 120 and the second motor 140. However, transmission of the driving force to the wheels by the first motor 120 requires coupling of the engine clutch 130.

Another example is an electric vehicle including wheels individually provided with different motors. When the available torque of the motor connected to one wheel (for example, the main drive wheel) is less than the total required torque, the motor connected to the other wheel (for example, an auxiliary wheel) may be additionally used.

On the other hand, when the first motor 120′ is connected to the engine 110 through a pulley and a belt rather than being disposed between the engine 110 and one end portion of the engine clutch 130 as illustrated in FIG. 1B, the same slope driving assist control may also be executed. Furthermore, when the first motor 120′ is configured as an auxiliary driving motor connected to the auxiliary driving wheels while the second motor 140 is configured as the main driving motor connected to the main driving wheels.

Furthermore, when a request for activation of the slope driving assist function is inputted, the control unit 320 may control so that the compensation torque is outputted through at least one of the first motor 120 and the second motor 140. The driver may decide whether or not to activate the slope driving assist function, and the compensation torque is outputted when the accelerator pedal is manipulated in consideration of the gradient by activating the slope driving assist function so that the occurrence of an unexpected driving feel such as a sudden unintended acceleration of the vehicle may be prevented. The request for activation of the slope driving assist function may be inputted through a terminal, an interface unit of the vehicle including the AVNT 340 to be described below, or the like.

The sensor 330 may detect the gradient of the driving road, and the control unit 320 may determine the compensation torque based on the gradient of the driving road upon receiving the detection result, improving the accuracy of the compensation torque determination. In the instant case, the sensor 330 may include an inclination sensor that allows the determination of the gradient of the driving road by detecting the inclination of the vehicle or an acceleration sensor which is configured to detect the acceleration of the vehicle and allows the determination of the gradient of the driving road through the forces acting on the vehicle and the detected acceleration.

Furthermore, the control unit 320 may determine whether or not the vehicle is driving on a slope based on the detection result of the gradient and execute the control for slope driving assist when the vehicle is determined to be driving on a slope.

The AVNT 340 may identify the current location of the vehicle and transmit the location to the control unit 320. Once the current location of the vehicle is received, the control unit 320 may determine the compensation torque based thereon, improving the accuracy of the compensation torque determination. Furthermore, the AVNT 340 may receive a request to activate the slope driving assist function from the driver and may execute a function of displaying matters related to the slope driving control for the driver to recognize the matters.

FIG. 3 describes a configuration of a vehicle including the slope driving assist function according to an exemplary embodiment of the present disclosure, and the determination of the compensation torque for the slope driving assist will be described in detail with reference to FIG. 4 below.

FIG. 4 is a view for describing the determination of compensation torque for slope driving assist according to an exemplary embodiment of the present disclosure.

FIG. 4 illustrates a vehicle entering the slope from an even road to keep driving thereon. When a vehicle drives on an even road, rolling resistance due to deformation of tire or road surface, unevenness of the road surface, and the like, air resistance according to the driving speed and shape of the vehicle, and acceleration resistance according to the inertial force of the vehicle come into force.

On the other hand, when a vehicle drives on a slope, the gradient resistance additionally applies, and the gradient resistance is determined by the weight of the vehicle (that is, the mass of the vehicle multiplied by the gravitational acceleration) and the gradient θ of the driving road. Because the gradient resistance applies during slope driving, the driver may not get the driving feel obtainable during even road driving when the accelerator pedal is manipulated in the same manner as during even road driving. Accordingly, slope driving requires the driver to manipulate the accelerator pedal differently compared to even road driving to get the desired driving feel, which increases the driving difficulty and generates an unusual feel in driving.

The vehicle including the slope driving assist function according to the exemplary embodiment to resolve the present issue determines the compensation torque in consideration of the gradient resistance during slope driving and causes at least one of the first motor 120 and the second motor 14 to output the total required torque including the compensation torque. This allows slope driving to be the same as even road driving, resolving the issue described above.

On the other hand, the control unit 320 may further consider a compensation coefficient preset to correspond to the driving behavior of the vehicle on the road with a specific gradient in determining the compensation torque. For example, the compensation coefficient may be set to 1 to correspond to the driving behavior during even road driving, or the compensation coefficient is set to 0.5 to correspond to the driving behavior during slope driving including half the gradient of the current driving road, and the compensation torque may be determined by multiplying the gradient resistance value according to the current gradient by the compensation coefficient. This allows adjustment of the compensation torque through the setting by the driver to secure the desired driving feel.

Furthermore, the control unit 320 may determine the compensation in further consideration of the weight condition of the vehicle. Here, the weight condition of the vehicle may include the weight of the occupants of the vehicle, loaded cargo, and the like as well as the weight of the vehicle. In the instant case, the weight condition may be determined by a fixed value preset for each vehicle or may be determined based on the behavior of the vehicle relative to the output torque. The weight of the vehicle is unlikely to deviate from a fixed range, but the total weight on the road may vary by the occupants or loaded cargo. When the compensation torque is determined through the determined weight condition of the vehicle based on the behavior of the vehicle relative to the output torque, the varying weight may be reflected so that the gradient resistance may be countered more substantially.

On the other hand, the control unit 320 may determine the compensation torque in further consideration of the road surface condition of the driving road. When the vehicle drives on a slope, not only does the overall driving resistance vary due to the gradient resistance, but the perpendicular component of the vehicle weight varies according to the gradient to affect the overall driving resistance. Here, the road surface condition may include a friction coefficient and a rolling resistance coefficient, and the road surface condition may be determined based on a preset fixed value or a road type. In the instant case, the road type may be determined based on the current position identified by the AVNT 340.

On the other hand, the control unit 320 may check the driving behavior of the vehicle according to the output of the total required torque of at least one of the first motor 120 and the second motor 140 and determine a degree of matching between the driving behavior and preset target behavior. Here, the behavior may include vehicle speed, instantaneous acceleration, and the like. The control unit 320 may adjust the compensation torque so that the degree of matching becomes equal to or greater than a preset value when the degree of matching between the driving behavior and the target behavior is less than the preset value, in which case the target behavior may be determined based on the driving behavior of the vehicle at a specific gradient and may be preset to correspond to the driving behavior of other vehicles as well as the vehicle that the driver is currently driving. This allows the execution of the driving assist control so that the driving behavior of the vehicle approaches the behavior desired by the driver. Furthermore, when the driver drives a vehicle other than the vehicle the driver usually drives, a certain driving feel may be ensured regardless of the change of vehicles.

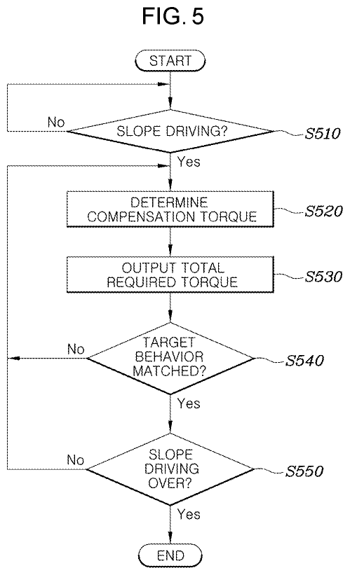

What has been described thus far may be summarized in the flowchart in FIG. 5. A method of controlling a vehicle including the slope driving assist function according to an exemplary embodiment will be described with reference to FIG. 5 below.

FIG. 5 is a flowchart illustrating a control process of a vehicle including a slope driving assist function according to an exemplary embodiment of the present disclosure.

FIG. 5 shows that the control unit 320 may check whether the vehicle is driving on a slope by determining the gradient of the driving road through the sensor 300 (S510). When the vehicle is determined to be driving on a slope (Yes in s510), the control unit 320 determines the compensation torque based on the gradient resistance according to the gradient of the driving road (S520). In the instant case, the control unit 320 may determine the compensation torque based on the gradient of the driving road and the vehicle weight and determine the compensation coefficient in further consideration of the compensation coefficient preset to correspond to the driving behavior of the vehicle on the road including a specific gradient or by reflecting the vehicle weight condition determined based on a preset value for each vehicle or vehicle behavior relative to the output torque and the road surface condition of the driving road determined by a preset value or a road type.

When the compensation torque is determined, the control unit 320 may allocate the total required torque to at least one of the first motor 120 and the second motor 140 based on whether the total required torque may be outputted from the second motor 140 (S530). In the instant case, the control unit 320 may cause a specific motor to output all the total required torque or allocate the total required torque to the plurality of motors 120, 140 based on the torque output specification of each motor, ensuring that the total required torque is outputted based on the allocation result. Furthermore, the control unit 320 may allocate the total required torque in further consideration of a torque output limit of the first motor 120 or the second motor 140.

After the total required torque is outputted in the step S530, the control unit 320 may check the driving behavior of the vehicle according to the total required torque output and determine the degree of matching between the driving behavior and the preset target behavior (S540). The control unit 320 may adjust the compensation torque so that the degree of matching is equal to or greater than a preset value when the degree of matching is less than the preset value (No in S540), in which case the target behavior may be determined based on the driving behavior of the vehicle at a predetermined gradient.

When the degree of matching between the driving behavior of the target according to the output of the total required torque and the target behavior is equal to or greater than a preset value (Yes in S540), the control unit 320 may cause at least one of the first motor 120 or the second motor 140 to output the compensation torque as determined. When the slope driving is terminated as a result of the gradient determination (Yes in S550), the slope driving assist control according to the exemplary embodiment of the present disclosure is terminated.

According to the various embodiment of the present disclosure described above, the slope driving assist allows slope driving to be similar to even road driving, reducing driving difficulty during slope driving. This allows the driver to readily get the desired driving feel, improving driving convenience and lowering the risk of accidents.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle including a slope driving assist function, the vehicle comprising:
a first motor and a second motor; and
a control unit configured to determine a compensation torque based on a gradient resistance according to a gradient of a driving road on which the vehicle is driving and allocate a total required torque including the compensation torque and driver's required torque to at least one of the first motor and the second motor according to whether the total required torque is outputted from the second motor.

2. The vehicle of claim 1, wherein the control unit is configured to determine the compensation torque in further consideration of a compensation coefficient applied to the gradient resistance.

3. The vehicle of claim 1,
wherein the control unit is configured to determine the compensation torque in further consideration of a weight condition of the vehicle, and
wherein the weight condition is determined based on driving behavior of the vehicle related to a preset value or an output torque for each vehicle.

4. The vehicle of claim 1,
wherein the control unit is configured to determine the compensation torque in further consideration of a road surface condition of the driving road, and
wherein the road surface condition is determined based on a preset value or a road type.

5. The vehicle of claim 4, further including an audio/video/navigation/telematics (AVNT) terminal for identifying a current location of the vehicle,
wherein the road type is determined based on the current location of the vehicle identified through the AVNT terminal.

6. The vehicle of claim 1, wherein the control unit is configured to check driving behavior of the vehicle according to outputting of the total required torque by at least one of the first motor and the second motor, determine a degree of matching between the driving behavior and a preset target behavior, and adjust the compensation torque so that the degree of matching is equal to or greater than a preset value when the degree of matching is less than the preset value.

7. The vehicle of claim 6, wherein the target behavior is determined based on the driving behavior of the vehicle at a predetermined gradient.

8. The vehicle of claim 1, wherein the control unit is configured to reserve at least a portion of an available torque of a motor among the first motor and the second motor, which is to output the compensation torque according to the allocation until the compensation torque is outputted through at least one of the first motor and the second motor.

9. The vehicle of claim 1, wherein the control unit is configured to allocate the total required torque so that the total required torque is outputted through the second motor.

10. The vehicle of claim 9, wherein the control unit is configured to control so that the first motor charges a battery according to a state of charge (SOC) value of the battery if the first motor generates power when the total required torque is outputted from the second motor.

11. The vehicle of claim 1, wherein the control unit is configured to allocate the total required torque so that output of the total required torque is split between the first motor and the second motor when all the total required torque is not outputted from the second motor.

12. The vehicle of claim 11, wherein in a case that a torque output of the first motor or the second motor is limited when all the total required torque is not outputted from the second motor, the control unit is configured to allocate the compensation torque to a motor among the first and second motors with limited torque output and the driver's required torque to another motor among the first and second motors.

13. The vehicle of claim 12, wherein the case in which the torque output of the first motor or the second motor is limited includes at least one of failure of the first motor or the second motor and overheating of the first motor or the second motor.

14. The vehicle of claim 1, wherein the control unit is configured to control so that the compensation torque is outputted through at least one of the first motor and the second motor when a request for activation of the slope driving assist function is inputted.

15. A method of controlling a vehicle including a slope driving assist function, the method comprising:
determining, by a control unit, compensation torque based on a gradient resistance according to a gradient of a driving road om which the vehicle is driving; and
allocating, by the control unit, a total required torque including the compensation torque and driver's required torque to at least one of a first motor and a second motor according to whether the total required torque is outputted from the second motor.

16. The method of claim 15, wherein the control unit is configured to determine the compensation torque in further consideration of at least one of a compensation coefficient applied to the gradient resistance, a weight condition of the vehicle, wherein the weight condition is determined based on driving behavior of the vehicle related to a preset value or an output torque for each vehicle, and a road surface condition of the driving road, wherein the road surface condition is determined based on a preset value or a road type.

17. The method of claim 15, wherein the control unit is configured to check driving behavior of the vehicle according to outputting of the total required torque by at least one of the first motor and the second motor, determine a degree of matching between the driving behavior and a preset target behavior, and adjust the compensation torque so that the degree of matching is equal to or greater than a preset value when the degree of matching is less than the preset value.

18. The method of claim 15, wherein the control unit is configured to reserve at least a portion of an available torque of a motor among the first motor and the second motor, which is to output the compensation torque according to the allocation until the compensation torque is outputted through at least one of the first motor and the second motor.

19. The method of claim 15, wherein the control unit is configured to allocate the total required torque so that the total required torque is outputted through the second motor.

20. The method of claim 15, wherein the control unit is configured to allocate the total required torque so that output of the total required torque is split between the first motor and the second motor when all the total required torque is not outputted from the second motor.
